(19) United States
(12) Patent Application Publication
(10) Pub. No.: US 2026/0230191 A1
(43) Pub. Date: Aug. 6, 2026

(54) OPTICAL INTERCONNECTS USING DIFFERENTIAL ELECTRO-OPTICAL COMPONENTS

(71) Applicant: Mellanox Technologies, Ltd., Yokneam (IL)

(72) Inventors: Isabelle CESTIER, Haifa (IL); Timothy De KEULENAER, Belgium (BE); Elad MENTOVICH, Tel Aviv (IL); Marijn VERBEKE, Gent (BE)

(21) Appl. No.: 19/043,595

(22) Filed: Feb. 3, 2025

(51) Int. Cl. H04B 10/80; H04B 10/40; H04B 10/516; H04B 10/524; H04B 10/54

(52) U.S. Cl. CPC H04B 10/802; H04B 10/40; H04B 10/5161; H04B 10/524; H04B 10/54

(57) ABSTRACT

In various embodiments optical interconnects and/or optical networks including optical interconnects are provided. In an example embodiment, an optical interconnect includes a transmitter assembly. The transmitter assembly includes a differential electro-optical component configured to generate a modulated optical signal; and a signal preparation component (e.g., SerDes, PCIe component, etc.), wherein the differential electro-optical component is configured to be directly driven by the signal preparation component.

### BACKGROUND

As artificial intelligence and/or machine learning use increases, the amount of information being communicated between large clusters of computing resources (e.g., graphical processing units (GPUs), central processing units (CPUs), data processing units (DPUs), and/or the like) is also increasing. Links between computing resources and/or chips thereof are based on copper cables (short reach) or optical cables. In the optical cables, the data to be transferred between chips (or switches) is encoded/decoded from electrical to optical signal (and vice versa) and conveyed via an optical fiber. The current systems use single-ended electro-optical (EO) components such as direct modulated lasers (DMLs), such as vertical cavity surface emitting lasers (VCSELs), or modulators (e.g., electro-absorption modulators (EAMs), Mach-Zehnder modulators (MZMs), ring resonator modulators (RRMs), and/or the like). Such single-ended electro-optical components are driven by dedicated driver components that require additional power to operate and are limited in how densely such interconnects can be placed due to cross-talk between nearby interconnects. Therefore, there is a need in the art for lower power optical interconnects and for optical interconnects that can be more densely positioned.

### GENERAL DESCRIPTION

Datacenters rely on a fast and robust communication infrastructure. This is achieved by using optical interconnects, especially between different server racks. Each physical link employing a single optical fiber may include multiple communication channels, which are distinguished by different wavelengths in wavelength division multiplexing (WDM) systems.

Conventional systems use single-ended electro-optical (EO) components such as direct modulated lasers (DMLs), such as vertical cavity surface emitting lasers (VCSELs), or modulators (e.g., electro-absorption modulators (EAMs), Mach-Zehnder modulators (MZMs), ring resonator modulators (RRMs), and/or the like). Such single-ended electro-optical components are driven by dedicated driver components. This configuration is costly in energy, space, and signal processing (e.g., to compensate for any distortions resulting from nonlinearities and performance of single ended EO components). Optical interconnects disclosed herein use low swing differential EO components, which can improve energy efficiency and reduce cost. In various embodiments, the differential EO components are configured to be driven directly by a serializer/deserializer component of the optical interconnect such that a dedicated driver component is not required. Moreover, such optical interconnects are less susceptible to crosstalk between EO components, enabling denser optical interconnect arrays to be used. The improved signal integrity (SI) associated with reduced crosstalk and reduced distortions (e.g., due to an external driver component not being used) further facilitates the enablement of transmit retimed optics (TRO) modules leading to a significantly reduced network power. Furthermore, the removal of an external driver will also reduce module power and cost, not only due to the driver but also due to the removal of power supplies, control signals and ICs needed by the external driver.

Various embodiments provide optical interconnects that each include a transmitter assembly and a receiver assembly. The optical interconnects may be configured to connect between chips or between different communication systems. For example, it might provide optical interconnecting for network interface controller (NIC) to switch, switch to switch, and/or chip to chip. Optical interconnects can be used in a variety of applications, such as switches, processing units (e.g., graphics processing units (GPUs), etc.). An optical interconnect can include an optical link (e.g., optical fiber) to transmit an optical signal. Optical interconnect bandwidth can be scaled by transmitting an optical signal including multiple wavelengths using the same optical link. In doing so, the transmitter is tuned to generate the optical signal including multiple carrier wavelengths. Moreover, each modulator of a modular array can be tuned to receive and modulate a respective carrier frequency. Ordering the multiple wavelengths can be important to ensure that the transmitter and receiver are properly communicating data contained within the optical signal.

In at least one example embodiment, the optical interconnect is part of a datacenter that corresponds to a collection of network devices, such as network switches (e.g., Ethernet switches, IP routers, multiservice platforms, various transmission network elements, legacy communication equipment, or in any other suitable communication system) connected with a collection of servers or compute nodes. A switch fabric serves to transfer the data between the switch ports. A switch fabric comprises one or more interconnect circuits, which may be arranged in various switch fabric architectures, e.g., m*m crossbar, Banyan, Benes, Omega, Clos, multi-plane, STS, TST, shared memory, buffered crossbar, any other suitable blocking or non-blocking architecture, or any applicable mixed architecture thereof. A switch fabric is realized in typical embodiments by hardware, which may comprise Field-Programmable Gate Arrays (FPGAs) and/or Application-Specific Integrated Circuits (ASICs), and in some implementations also bus interconnects. The datacenter may adhere to a networking topology (e.g., a hierarchal networking topology), such as a fat tree topology, a Slim Fly topology, a Dragonfly topology, and/or the like. The datacenter routes traffic amongst the network switches and servers therein, and at least one layer of the topology in the datacenter is coupled to the communication network to allow networking traffic to flow between the datacenter and the network device(s).

The optical interconnect may include a substrate and an electro-optical component (VCSEL, photodiode, etc.) supported by the substrate and configured to convert between electrical and optical signals. The optical interconnect may further include a transmission block defining a receiving surface configured to receive an optical fiber, and a waveguide configured to transmit optical signals between the electro-optical component and the receiving surface such that in an operational configuration in which the receiving surface receives an optical fiber, the electro-optical component and the optical fiber are in optical communication.

While the present disclosure illustrates and describes the optical interconnect without a housing or other protective casing, as would be understood by one of ordinary skill in the art in light of the present disclosure, some or all of the optical interconnect may be supported or enclosed by any housing used in communications systems to protect the components supported therein (e.g., as part of Quad Small Form-factor Pluggable (QSFP) connectors, Small Form Pluggable (SFP) connectors, or the like). Furthermore, the substrate hosting the electro-optical component may be substantially rectangular shape and/or may be dimensioned (e.g., sized and shaped) for use in any communication system regardless of geometric constraints (e.g., L-shaped, squared-shaped, etc.).

In various embodiments, an optical interconnect for receiving an optical fiber may be implemented in a flip-chip configuration. In certain embodiments, the optical interconnect is configured as a flip-chip component such that a longitudinal axis of the first adiabatic transition profile of the optical interconnect and a longitudinal axis of the second adiabatic transition profile of the optical interconnect may be collinear. Said differently, the orientation of the optical interconnect in such an embodiment does not require a mirror or other reflective surface to redirect optical signals between the electro-optical component and the receiving surface. As would be evident to one of ordinary skill in the art in light of the present disclosure, however, the optical interconnect in a flip-chip configuration may also include one or more mirrors (e.g., reflective surfaces) to accommodate optical fibers received at varying angles. In some optical interconnect embodiments, only mirrors may be operationally configured to redirect light given that at some bending radii, light may remain confined to the waveguide. Accordingly, embodiments of a field replaceable modular optical interconnect unit are described that are configured to be received by a main switch system box. The field replaceable modular optical interconnect unit comprises a housing comprising at least a front panel, a rear panel, and side panels extending between the front and rear panels, a printed circuit board assembly supported within the housing, an optical module supported on the printed circuit board assembly and configured to convert between optical signals and corresponding electrical signals for respectively transmitting or receiving optical signals through a fiber optic cable, a board-to-board connector disposed on the rear panel of the housing and configured to enable electrical signals to be transmitted between the printed circuit board assembly and a main switch system box, and an external connector disposed on the front panel of the housing and configured to engage an external optical fiber for transmitting optical signals between the optical module and an external component. The field replaceable modular optical interconnect unit may be configured to be electrically connected to the main switch system box via engagement of the board-to-board connector with a corresponding connector of the main switch system box when the housing is received by the main switch system box.

In some embodiments, the optical module may be a mid-board optical module (MBOM), and/or the field replaceable modular optical interconnect unit may comprise a plurality of external connectors. For example, the external connector may be a first external connector, and the field replaceable modular optical interconnect unit may further comprise a second external connector disposed on the front panel of the housing and configured to enable transmission of electrical signals between the printed circuit board assembly and an external component connected thereto.

An optical interconnect typically comprises a driver circuit which drives an electro-optical element such as a light emitter (typically with a signal that can be represented by a binary or digital data stream), a waveguide (typically an optical fiber), and a receiver. In such a setup the light emitter typically consumes a significant part of the power requirement of the optical interconnect. An optical interconnect is typically composed by a transceiver module in each end adapted to transmit and receive optical information along one or more optical fibers. The transmitter of each transceiver typically comprises a driver circuit coupled to a light source (e.g., direct modulated laser(s), laser(s) coupled to respective modulator(s), and/or the like) and the receiver of each transceiver comprises a circuit coupled to a photo detector. Typically optical fibers are used as transmission medium in which case the light source and photo detector will be coupled to fibers. A driver circuit (often located on a driver chip) is a circuit tailored to generate a waveform appropriate to drive a light emitting device or light source in response to an input signal which is typically a binary or digital data stream (e.g. non-binary input signal such as PAM4). The combination of a driver circuit (e.g. linear drive pluggable optics), and possibly other electrical circuitry such as a SerDes, for example, and a light source is referred to as a transmitter. A receiver circuit (often located on a receiver chip) is a circuit tailored to receive the output from the light detector and generate a corresponding output signal. This output signal is typically an analog waveform, which may be further digitized by an Analog-to-Digital Converter (ADC) for processing as a binary or digital data stream (e.g., a non-binary signal such as PAM4). The combination of a receiver circuit and a light detector is referred to as a receiver. Often the receivers and transmitters provide multiple channels, i.e., the ability to transmit or receive via multiple light sources or photodetectors. Sometimes driver and receiver circuits are combined on the same chip which is then referred to as a transceiver chip. Besides driver, receiver and/or transceiver chips, optical modules may comprise further chips and electronics such as e.g., a microcontroller. Typically, the binary or digital signal used in such optical links is an amplitude modulated non-return to zero (NRZ) signal or pulse amplitude modulation 4-level (PAM4) but other signal types are in principle possible.

In a typical optical interconnect Vertical Cavity Surface Emitting Laser (VCSEL) diodes are utilized as light emitters to transmit binary or digital data over optical fibers. However, the light source may in principle be any suitable light source and the transmitted waveform may be any suitable waveform for transmitting information. Most light emitters have a threshold current above which they substantially begin to emit light. Increasing the current driven through the emitter from zero to above said threshold may be time consuming, and therefore a bias current is typically driven through the light source. Often the bias current is set just below, at the threshold or above the threshold, but it may also be set to be well above threshold. This bias current is often programmable so as the same circuit design may be utilized to drive different light emitters and/or be used for different applications. Additional time varying current which modulates the emission from the light emitter is referred to as the modulation current.

In some embodiments, the disclosed technique provides an EO interconnect assembly comprising a pair of pluggable EO transceivers connected at respective ends of an optical fiber. The EO transceivers are typically used to connect network-connected devices (e.g., remote client switches, network adapters such as Network Interface controllers (NICs) and Host Channel Adapters (HCAs), Smart-NICs (NICs having embedded CPUs), network-enabled Graphics Processing Units (GPUs), and the like). The terms “network-connected device” and “network device” are used interchangeably herein. In certain embodiments, an optical interconnect includes a substrate, one or more optical waveguides, one or more first micro-lenses, one or more second micro-lenses, and first and second mechanical fixtures. Moreover, when designing an optical interconnect module, it is highly desirable to place the EO component driving circuitry in close proximity to the EO transducers, in order to maintain high signal integrity. As a result, however, heat generated in the driving circuitry may increase the junction temperatures of the transducers and thus degrade their performance.

In order to resolve the above-described heat removal issues, the disclosed optical interconnect modules comprise removal of the EO driving circuitry from the optical interconnect module. For example, various embodiments provide optical interconnects that do not require driving circuitry configured for driving the EO component of the optical interconnect, thereby reducing heating of the EO component as a result of nearby EO driving circuitry.

In various embodiments, an optical interconnect includes a transmitter assembly and a receiver assembly. The transmitter assembly and the receiver assembly are in optical communication with one another via an optical fiber. The transmitter assembly includes a differential EO component configured to generate an optical signal and a signal preparation component configured to directly drive the differential EO component. In various embodiments, the signal preparation component is a serializer/deserializer (SerDes), a Peripheral Component Interconnect Express (PCIe) component, and/or the like). As used herein, a PCIe component comprises and/or consists of circuitry and/or hardware elements configured to operate in accordance with the PCIe interface standard. For example, a pair of electrical signals provided as input to the differential EO component are generated and provided by the signal preparation component. In other words, the differential EO component is not driven by a dedicated driver component (e.g., a component of the transmitter assembly with the sole function of driving the EO component).

In various embodiments, the use of the differential EO components to generate the optical signals and directly driving the EO component using the signal preparation component (e.g., SerDes, PCIe component, and/or the like) reduces the power consumption of the transmitter assembly (e.g., compared to conventional optical interconnects). Additionally, the use of the differential EO components reduces the susceptibility of the optical interconnects to crosstalk. Thus, denser arrays of optical interconnects may be used (e.g., compared to conventional optical interconnects) without negatively affecting the signal-to-noise (SNR) ratio and/or the bit error rate (BER) of the optical interconnects.

Dense low-power interfaces are paramount to continue scaling artificial intelligence (AI)/machine learning (ML) systems to interconnect large clusters (graphical processing units (GPUs), central processing units (CPUs), data processing units (DPUs), quantum processing units (QPUs), parallel processing units (PPUs), etc.). Compared to conventional optical interconnects, implementation a differential EO component based optical interconnect lower power consumption and is able to be more densely configured.

According to one aspect of the present disclosure, an optical interconnect includes a transmitter assembly including a differential electro-optical component configured to generate a modulated optical signal; and a signal preparation component (e.g., serializer/deserializer (SerDes), Peripheral Component Interconnect Express (PCIe) component, and/or the like). The differential electro-optical component is configured to be directly driven by the signal preparation component.

In an example embodiment, the differential electro-optical component is configured to receive at least one pair of electrical inputs and provide an optical output based on a comparison of the at least one pair electrical inputs. For example, the optical output may be generated based on the difference between the electrical inputs of the pair of electrical inputs. In various scenarios, this causes the optical output to be generated based on a common-mode signal present in both electrical inputs of the pair of electrical inputs and causes noise to be rejected. In an example embodiment, the signal preparation component is a SerDes and/or a PCIe component that comprises circuitry configured to convert serial data to parallel data (and vice-versa). In certain embodiments, the SerDes is comprised in the physical layer of the Open System Interconnections (OSI) model.

In certain embodiments, the differential electro-optical component is configured to have a 3 dB bandwidth of at least 60 GHz, a modulation voltage of no more than 0.9 peak-to-peak voltage (Vpp) differential into 86 Ohms, a relative intensity noise (RIN) referred to optical modulation amplitude (OMA) measured at 3.5 dBm of no more than −150 dBc/Hz, a radiofrequency (RF) facet optical power of at least 5 dBm, a differential input reflection coefficient (SDD11) with reference 86 Ohms of no more than −15 dB up to 45 GHz and of no more than −12 dB up to 60 GHz. In certain embodiments where the optical interconnect is configured for performing pulse amplitude modulation 4 (PAM4) transmission, the differential electro-optical component is configured to have an outer RF extinction ratio of at least 5 dB and a linearity of at least 0.95. As should be understood, similar optical interconnects may be configured for PAM6, PAM8, PAM16, or other modulation schemes to encode digital data onto/into the optical signal. Corresponding parameter sets may be determined for such modulation schemes. Such parameter sets may be determined using the method illustrated in FIG. 4, for example.

In an example embodiment, the transmitter assembly is configured to transmit the modulated optical signal, wherein the modulated optical signal encodes one or more data streams. The signal preparation component is configured to drive the differential electro-optical component to cause the modulated optical signal to encode the one or more data streams. The optical interconnect may further include a receiver assembly, the receiver assembly comprising an optical detector configured to convert the optical signal into at least one electrical signal encoding the one or more data streams. For example, the receiver assembly may further include a receiver signal processing component configured to convert the at least one electrical signal encoding the one or more data streams into individual electrical signals each encoding one of the one or more data streams.

In an example embodiment, the differential electro-optical component comprises a laser and a differential electro-optical modulator configured to modulate an output of the laser. In an example embodiment, the differential electro-optical component comprises an electro-absorption modulated laser (EML). In an example embodiment, the differential electro-optical component comprises a distributed feedback (DFB)-Mach-Zehnder modulator (MZM) chip (e.g., a DFB laser coupled to an MZM). In an example embodiment, the differential electro-optical component comprises a dual Mach-Zehnder modulator (DMZ) or a ring resonator modulator (RRM).

In an example embodiment, the signal preparation component is configured to provide a pair of electrical inputs to the differential electro-optical component. For example, the signal preparation component may be configured to provide the pair of electrical inputs to the differential electro-optical component without providing any input to a laser driver in electrical communication that is in communication with the different electro-optical component.

According to another aspect, an optical network is provided. The optical network includes a plurality of optical interconnects, each optical interconnect comprising a respective differential electro-optical component driven directly by a respective signal preparation component.

In certain embodiments, the plurality of optical interconnects are arranged into one or more groups with at least one group having a density of at least two optical interconnects per square millimeter or at least 400 Gbps per square millimeter.

In certain embodiments, the respective differential electro-optical component is configured to have a 3 dB bandwidth of at least 60 GHz, a modulation voltage of no more than 0.9 peak-to-peak voltage (Vpp) differential into 86 Ohms, a relative intensity noise (RIN) referred to optical modulation amplitude (OMA) measured at 3.5 dBm of no more than −150 dBc/Hz, a radiofrequency (RF) facet optical power of at least 5 dBm, and a differential input reflection coefficient (SDD11) with reference 86 Ohms of no more than −15 dB up to 45 GHz and of no more than −12 dB up to 60 GHz. In an example embodiment configured for performing pulse amplitude modulation 4 (PAM4) transmission, the differential electro-optical component is configured to have an outer RF extinction ratio of at least 5 dB and a linearity of at least 0.95.

According to another aspect, a method for designing an optical interconnect is provided. In an example embodiment, the method includes generating an interconnect model that models interaction between components of a transmitter assembly of the optical interconnect and components of a receiver assembly of the optical interconnect; and determining one or more parameters of one or more components of at least one of the transmitter assembly or the receiver assembly so as to provide a differential return loss of the optical interconnect that satisfies one or more threshold criteria under at least one noise criteria.

The present disclosure describes interconnects (e.g., interconnect topologies) that are scalable and advantageous for networks that require a large number of all-to-all or point-to-point links between one or more node or send/receive pairs. In particular, silicon photonics interconnects or topologies are provided herein that may achieve at least moderate bandwidth between many nodes with physical, optical fiber connections. In some implementations, the one or more node or send/receive pairs are coupled with an optical fiber allowing a single wavelength to pass therebetween. In other implementations, multiple wavelengths or groups of wavelengths may be transmitted or received by nodes while simultaneously passing multiple wavelengths or groups of wavelengths to other nodes via optical fiber loops connecting three or more nodes. In some implementations, such interconnects as described herein do not rely on or include one or more of the following: wavelength synchronization between transmit and receive pairs, arbitration of the fiber(s), demultiplexers on the receiver side, and/or an optical crossbar. In some implementations, the optical interconnects may be sized to fit a face-plate form factor or as a mid-board optical connector or co-packaged optics. In some embodiments, the present disclosure provides optical interconnects for high bandwidth density applications like switches and GPUs or other processing elements. In one example, the processing elements may include central processing units (CPUs), graphics processing units (GPUs), data processing units (DPUs), quantum processing units (QPUs), a plurality of parallel processing units (PPUs), and application-specific integrated circuits (ASICs). QPUs are configured to perform one or more operations associated with a quantum algorithm. In some embodiments, each of the one or more QPUs may include a plurality of qubits and the one or more QPUs may be in communication with each other via a quantum channel. In some embodiments, each of the plurality of qubits may include local qubits, global qubits, and/or synchronization qubits. In some embodiments, the local qubits of each QPU may be configured to perform the one or more operations associated with the quantum algorithm on the QPU that the local qubits are associated with.

A “node” as described herein may refer to a network switch to which a plurality of computer processing units (CPUs), graphical processing units (GPUs), data processing units (DPUs), or memory media are connected in an arbitrary number. The network switch may communicate with other network switches of the same kind to which the same processor and memory units may be connected. However, in other implementations, “node” may also refer to a processor which may be responsible for communication with all other nodes in the network or subnetwork.

An “optical fiber” as described herein can refer to a single optical fiber (e.g., including a core and a cladding) to provide unidirectional optical communication, can refer to a bidirectional pair of optical fibers (e.g., each including a core and a cladding) to provide both transmit and receive communications in an optical network, or can refer to a multi-core fiber, such that a single cladding could encapsulate a plurality of single-mode cores. Optical fibers can extend contiguously and uninterrupted between node or send/receive pairs (e.g., via pass-through connections) or include two or more fibers connected via fiber-to-fiber connections such that the fibers function or perform as a single fiber.

Silicon Photonics (SiP) is a technology that enables optical systems to be manufactured using silicon processes with silicon as the optical medium. Various optical components, such as interconnects and signal processing components, may be fabricated and integrated in a single SiP device. Some SiP devices are fabricated on a silica substrate or over a silica layer on a silicon substrate, a technology that is often referred to as Silicon on Insulator (SOI). In certain optical systems, a SiP device is attached to an external device to facilitate optical communications. However, it is generally difficult to accurately align light signals on the SiP with an external device that receives the light.

In certain optical systems, a SiP device is attached to an external device to facilitate optical communications. For example, the system includes one or more waveguides that carry light signals to and/or from optical chips. Examples of optical chips that can be included on the device include, but are not limited to, one or more components selected from a group consisting of facets through which light signals can enter and/or exit a waveguide, entry/exit ports through which light signals can enter and/or exit a waveguide from above or below the device, multiplexers for combining multiple light signals onto a single waveguide, demultiplexers for separating multiple light signals such that different light signals are received on different waveguides, optical couplers, optical switches, lasers that act as a source of a light signal, amplifiers for amplifying the intensity of a light signal, attenuators for attenuating the intensity of a light signal, modulators for modulating a signal onto a light signal, modulators that convert a light signal to an electrical signal, and vias that provide an optical pathway for a light signal traveling through the device. Additionally, the device can optionally, include electrical components. For instance, the device can include electrical connections for applying a potential or current to a waveguide, controlling active optical components, such as modulators, for example, and/or for controlling other components on the optical device.

### BRIEF DESCRIPTION OF THE SEVERAL VIEWS OF THE DRAWINGS

Reference will now be made to the accompanying drawings, which are not necessarily drawn to scale, and wherein:

FIG. 1 provides a block diagram of an example optical interconnect, in accordance with certain embodiments;

FIGS. 1A, 1B, and 1C each provide a block diagram of an example differential electro-optical (EO) component, in accordance with certain embodiments;

FIG. 2A provides a schematic top view of an example of the transmitter assembly of an optical interconnect, in accordance with certain embodiments;

FIG. 2B provides a schematic sideview of the example of the transmitter assembly of an optical interconnect illustrated in FIG. 2A;

FIG. 2C provides a schematic sideview of a conventional transmitter assembly of an optical interconnect;

FIG. 2D provides a schematic top view of the conventional transmitter assembly of an optical interconnect shown in FIG. 2C;

FIG. 3 provides a block diagram of an example optical network comprising a plurality of optical interconnects, according to certain embodiments;

FIG. 4 provides a flowchart illustrating various processes, procedures, and/or operations for designing an optical interconnect, according to certain embodiments;

FIG. 5 provides a plot showing the differential return loss as a function of frequency and a corresponding Smitch chart for an example set of parameters for an optical interconnect model, according to certain embodiments;

FIGS. 5A-5F provide plots showing differential return loss as a function of frequency for a plurality of sets of parameters for an optical interconnect model, according to certain embodiments;

FIG. 6 provides a block diagram of an example system that may include one or more optical chips according to certain embodiments;

FIG. 7 provides a schematic diagram of an example datacenter that may include one or more optical chips according to certain embodiments;

FIG. 8 provides a block diagram of two example communication devices in communication with one another according to certain embodiments;

FIG. 9 depicts some exemplary scenarios for use of an optical transceiver, in accordance with various embodiments;

FIG. 10 provides a block diagram that schematically illustrates a computing system that may include one or more optical interconnects of various embodiments;

FIG. 11 illustrates an example computing environment, in accordance with at least one embodiment; and

FIG. 12 illustrates another example computer system that may include optical interconnects, according to at least one embodiment.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

Various embodiments provide an optical interconnect that includes a transmitter assembly that includes a differential electro-optical (EO) component configured to generate optical signals. As used herein, a differential EO component is an EO component that is configured to receive a pair of electrical inputs and to provide an optical output based on a comparison of the pair of electrical signals. Some non-limiting examples of differential EO components include an electro-absorption modulated laser (EML) and a laser coupled to a dual Mach-Zehnder modulator (DMZ).

In various embodiments, the transmitter assembly comprises a signal preparation component. In various embodiments, the signal preparation component may be a SerDes, PCIe component, and/or the like. The signal preparation component is configured to receive electrical signals that encode data streams to be communicated via the optical interconnect (e.g., from a source processing element to a receiver processing element). The signal preparation component provides a pair of electrical signals to the differential EO component that are used to drive the differential EO component and/or to control the output optical signal generated by the differential EO component.

In various embodiments, the differential EO component is configured to be driven directly by the signal preparation component (e.g., without an intervening driver component or a dedicated driver component). For example, the signal preparation component may have differential outputs which may be used to directly drive the differential EO component as long as they fulfil a set of conditions. The impedance of the devices (e.g., the differential EO component and any other components along the electrical connections between the signal preparation component and the differential EO component (e.g., bias Ts, and/or the like) should match the signal preparation component load to avoid electrical reflection. The modulation voltage needed to generate the optical data signal that is transmitted with the necessary quality (eye opening, linearity, error) over the link should be equal or lower than the output voltage of the signal preparation component. The relative intensity noise (RIN) parameter should be defined such as not to constrain the noise link figure. For example, in certain embodiments, the differential EO component is configured to have a 3 dB bandwidth of at least 60 GHz, a modulation voltage of no more than 0.9 peak-to-peak voltage (Vpp) differential into 86 Ohms, a relative intensity noise (RIN) referred to optical modulation amplitude (OMA) measured at 3.5 dBm of no more than −150 dBc/Hz, a radiofrequency (RF) facet optical power of at least 5 dBm, and/or a differential input reflection coefficient (SDD11) with reference 86 Ohms of no more than −15 dB up to 45 GHz and of no more than −12 dB up to 60 GHz. In example embodiments where the optical interconnect is configured for performing pulse amplitude modulation 4 (PAM4) transmission, the differential EO component is configured to have an outer RF extinction ratio of at least 5 dB and a linearity of at least 0.95. In various embodiments, configuring the differential EO component in accordance with these parameters enables the differential EO component to be driven directly by the signal preparation component of the transmitter assembly.

Conventional optical interconnects use single-ended electro-optical (EO) components such as direct modulated lasers (DMLs), such as vertical cavity surface emitting lasers (VCSELs), or modulators (e.g., electro-absorption modulators (EAMs), Mach-Zehnder modulators (MZMs), ring resonator modulators (RRM), and/or the like). Such single-ended EO components are driven by dedicated driver components. For example, attempting to drive such single-ended EO components directly by the SerDes would result in a non-functional optical interconnect. This conventional configuration is costly in energy, space, and signal processing (e.g., to compensate for any distortions resulting from nonlinearities and performance of single ended EO components). Moreover, such single-ended EO components are susceptible to crosstalk between nearby optical interconnects. As a result, the conventional optical interconnects must be arranged in arrays that are sufficiently spaced to prevent crosstalk from negatively impacting the BER and/or SNR of the optical interconnects. However, dense low-power interfaces are paramount to continue scaling AI/ML systems to interconnect large clusters (GPUs, CPUs, DPUs, . . . ). Therefore, technical problems exist regarding how to provide dense low-power interfaces between processing elements (e.g., chips, GPUs, CPUs, DPUs, . . . ).

Various embodiments provide technical solutions to these technical problems. Optical interconnects disclosed herein use low swing differential EO components, which can improve energy efficiency and reduce cost. In various embodiments, the differential EO components are configured to be driven directly by a (transmitter) signal preparation component (e.g., SerDes, PCIe component, etc.) of the optical interconnect such that a dedicated driver component is not required. Moreover, such optical interconnects are less susceptible to crosstalk between EO components, enabling denser optical interconnect arrays to be used. The improved signal integrity (SI) associated with reduced crosstalk and reduced distortions (e.g., due to an external driver component not being used) further facilitates the enablement of transmit retimed optics (TRO) modules leading to a significantly reduced network power.

Thus, various embodiments provide technical improvements to the fields of optical interconnects, optical networks, data processing centers, optical communications, and/or the like.

### Example Optical Interconnect

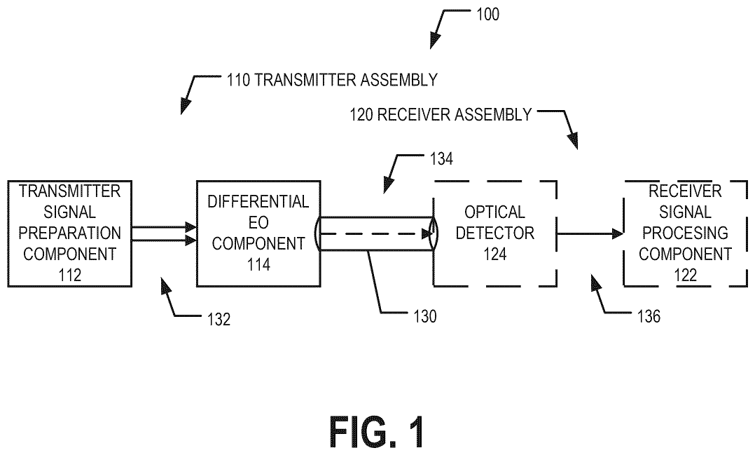

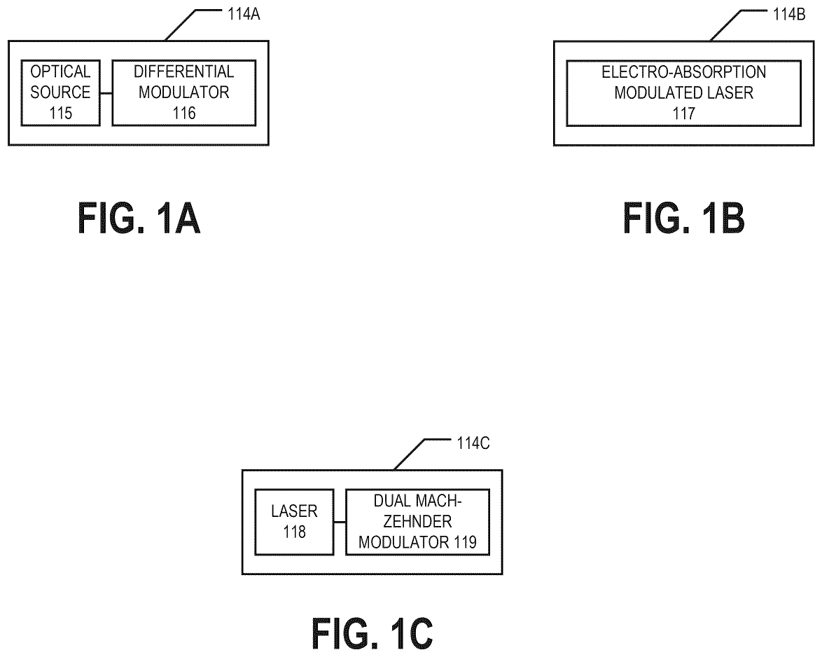

FIG. 1 illustrates a block diagram of an example optical interconnect 100, according to an example embodiment. The illustrated optical interconnect 100 includes a transmitter assembly 110 and a receiver assembly 120. The transmitter assembly 110 is in optical communication with the receiver assembly 120 via optical fiber 130.

The transmitter assembly 110 includes a transmitter signal preparation component 112 and a differential EO component 114. The transmitter signal preparation component 112 is configured to provide a pair of electrical inputs 132. The pair of electrical inputs 132 are configured to drive the differential EO component 114 so as to cause the differential EO component 114 to generate a modulated optical signal 134 that encodes one or more data streams. For example, the differential EO component 114 is configured to receive at least one pair of electrical inputs and provide an optical output based on a comparison of the at least one pair electrical inputs.

For example, the optical interconnect may be configured to communicate one or more data streams from a first processing element to a second processing element. The transmitter signal preparation component 112 (e.g., a SerDes, a PCIe component, and/or the like) receives the one or more parallel data streams from the first processing unit and generates the pair of electrical inputs 132 corresponding to a serialized data stream generated by serializing the one or more parallel data streams. For example, the transmitter signal preparation component 112 may comprise circuitry configured to convert parallel data to serial data.

The transmitter signal preparation component 112 provides the pair of electrical inputs 132 such that the pair of electrical inputs 132 are incident at the electrical inputs of the differential EO component 114. Based at least in part on the pair of electrical inputs 132 and/or a comparison thereof, the differential EO component 114 generates a modulated optical signal 134 that encodes the serialized data stream. The modulated optical signal 134 is guided and/or provided to the receiver assembly 120 of the optical interconnect 100 via the optical fiber 130 or another optical guide (e.g., waveguide and/or the like).

In various embodiments, the optical interconnect comprises a light coupling module for coupling the optical signals between the optical fibers 130 and the EO transducers. In various embodiments, the light coupling module comprises light coupling elements such as micro-lenses or prisms configured to couple the optical signal into the optical fiber and/or waveguide.

In various embodiments, the receiver assembly 120 comprises an optical detector 124 and a receiver signal processing component 122. In various embodiments, the receiver signal processing component 122 is a SerDes, a PCIe component, and/or the like. The modulated optical signal 134 is incident on the optical detector 124. In various embodiments, the optical detector 124 is a photodetector, photodiode, phototransistor, metal-semiconductor-metal (MSM) photodetector, avalanche photodiode, charge-coupled device (CCD), complementary metal-oxide-semiconductor (CMOS) image sensor, photomultiplier tube, and/or another optical detector. The optical detector 124 converts the modulated optical signal 134 into at least one electrical signal 136 encoding the serialized data stream formed by serializing the one or more parallel data streams. The optical detector 124 provides the at least one electrical signal 136 encoding the serialized data stream to the receiver signal processing component 122. The receiver signal processing component 122 receives the at least one electrical signal 136 as input and provides one or more (serial) data streams to the second processing element.

For example, the receiver signal processing component 122 may de-serialize a plurality of parallel data streams that were serialized by the transmitter signal preparation component 112 and then provided to the receiver assembly 120 via the modulated optical signal 134. For example, the receiver signal processing component 122 may comprise circuitry configured to convert serial data to parallel data. The plurality of parallel data streams may then be provided to the second processing element to complete the communication of the one or more data streams from the first processing element to the second processing element via the optical interconnect 100.

In various embodiments, the differential EO component 114 is configured to generate a modulated optical signal 134 based at least in part on a pair of electrical inputs 132. FIGS. 1A-1C provide block diagrams of some example differential EO components 114A-114C, in accordance with various embodiments. For example, the differential EO component 114A includes an optical source 115 and a differential modulator 116. The optical source 115 may be a laser, direct feedback laser, electro-absorption modulated laser, diode laser, LED laser, vertical cavity surface emitting laser (VCSEL), optical amplifier, optical cavity, and/or the like. The differential modulator 116 may be any type of modulator that modulates an optical signal based on a pair of electrical inputs (e.g., a dual Mach-Zehnder modulator (DMZ), a differential electro-absorption modulator (EAM), and/or the like). For example, the optical source 115 may be configured to generate a (non-modulated) continuous wave optical signal. The (non-modulated) continuous wave optical signal is then modulated by the differential modulator 116 to encode the one or more (parallelized) data streams into the optical signal such that the modulated optical signal 134 is generated.

The differential EO component 114B comprises an electro-absorption modulated laser (EML) 117. For example, the EML 117 may be driven by the pair of electrical inputs 132 to generate and provide the modulated optical signal 134.

The differential EO component 114C comprises a DMZ 119 coupled to a laser 118. For example, the laser 118 may provide a continuous wave laser beam that is modulated by the DMZ 119 based on the pair of electrical inputs 132 to generate the modulated optical signal 134.

In various embodiments, the differential EO component 114 is configured to be driven directly by transmitter signal preparation component 112. For example, a pair of electrical inputs 132 provided as input to the differential EO component 114 are generated and provided by the transmitter signal preparation component 112. In other words, the differential EO component 114 is not driven by a dedicated driver component (e.g., a component of the transmitter assembly 110 with the sole function of driving the differential EO component 114).

In various embodiments, the differential EO component 114 is configured to be driven directly by the transmitter signal preparation component 112 when the differential EO component 114 is characterized by one or more parameter values summarized in Table 1. For example, in certain embodiments, the differential EO component is configured to be driven directly by the transmitter signal preparation component 112 when the differential EO component is configured to have at least one of a 3 dB bandwidth of at least 60 GHz, a modulation voltage of no more than 0.9 peak-to-peak voltage (Vpp) differential into 86 Ohms, a relative intensity noise (RIN) referred to optical modulation amplitude (OMA) measured at 3.5 dBm of no more than −150 dBc/Hz, a radiofrequency (RF) facet optical power of at least 5 dBm, a differential input reflection coefficient (SDD11) with reference 86 Ohms of no more than −15 dB up to 45 GHz and of no more than −12 dB up to 60 GHz, an outer RF extinction ratio of at least 5 dB, or a linearity, expressed as level separation mismatch ratio (RLM) of at least 0.95.

TABLE 1

| Parameters | Value |
|---|---|
| 3 dB bandwidth | Minimum 60 GHz |
| Modulation voltage | Maximum 0.9 Vpp differential into 86 Ohm |
| Outer RF Extinction Ratio | Minimum 5 dB (PAM4 signaling) |
| RIN OMA | Maximum −150 dBc/Hz (at OMA 3.5 dBm) |
| RF facet optical power | Minimum 5 dBm |
| SDD11 (reference 86 | Maximum −15 dB up to 45 GHz; −12 dB |
| Ohms) | up to 60 Ghz |
| Linearity (RLM) | Minimum 0.95 (PAM4) |

In certain embodiments, the differential EO component is configured to be driven directly by the transmitter signal preparation component 112 when the differential EO component is configured to have each of a 3 dB bandwidth of at least 60 GHz, a modulation voltage of no more than 0.9 peak-to-peak voltage (Vpp) differential into 86 Ohms, a relative intensity noise (RIN) referred to optical modulation amplitude (OMA) measured at 3.5 dBm of no more than −150 dBc/Hz, a radiofrequency (RF) facet optical power of at least 5 dBm, a differential input reflection coefficient (SDD11) with reference 86 Ohms of no more than −15 dB up to 45 GHz and of no more than −12 dB up to 60 GHz, an outer RF extinction ratio of at least 5 dB, and a linearity of at least 0.95.

In some embodiments, the differential EO component is configured to be driven directly by the transmitter signal preparation component 112 when the differential EO component is configured to have a 3 dB bandwidth of at least 60 GHz, a modulation voltage of no more than 0.9 peak-to-peak voltage (Vpp) differential into 86 Ohms, a relative intensity noise (RIN) referred to optical modulation amplitude (OMA) measured at 3.5 dBm of no more than −150 dBc/Hz, a radiofrequency (RF) facet optical power of at least 5 dBm, and/or a differential input reflection coefficient (SDD11) with reference 86 Ohms of no more than −15 dB up to 45 GHz and of no more than −12 dB up to 60 GHz. In such embodiments configured to use a PAM4 modulation scheme, the differential EO component is further configured to have an outer RF extinction ratio of at least 5 dB and/or a linearity of at least 0.95.

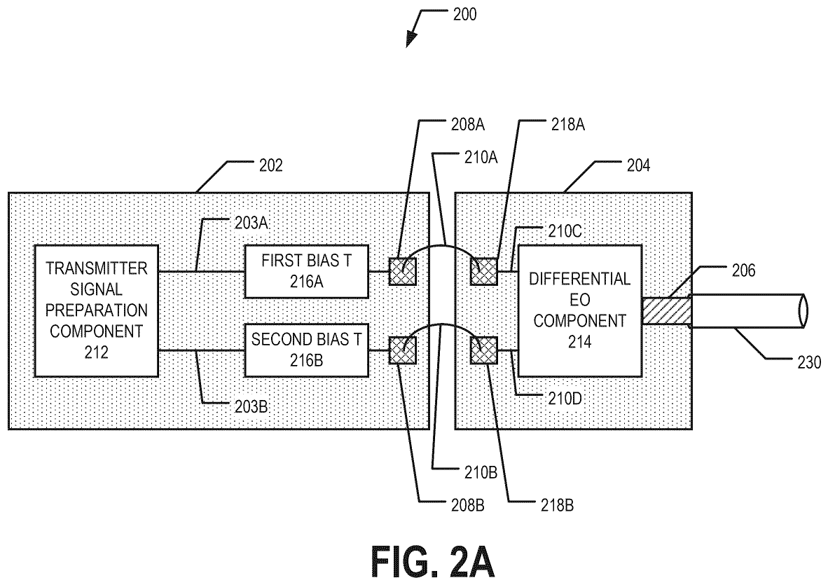

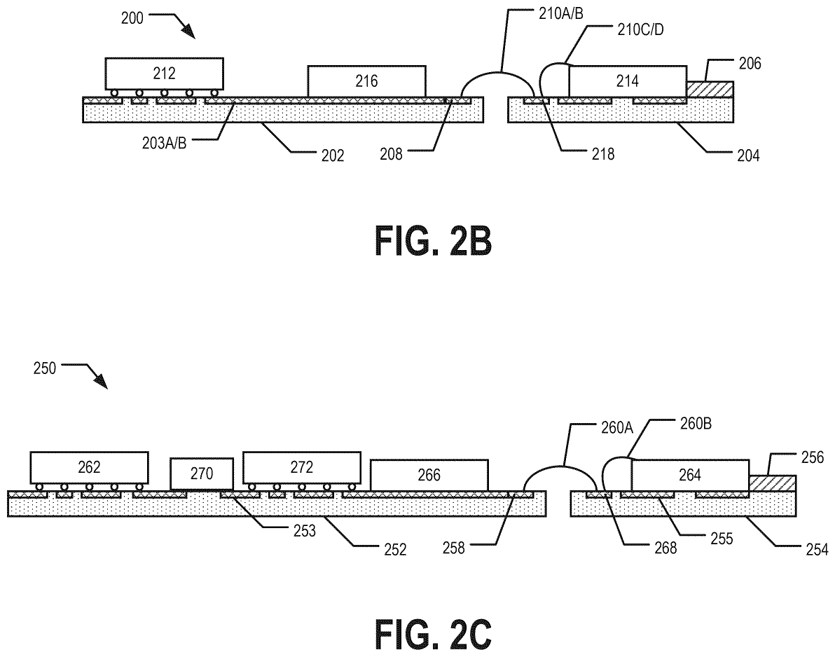

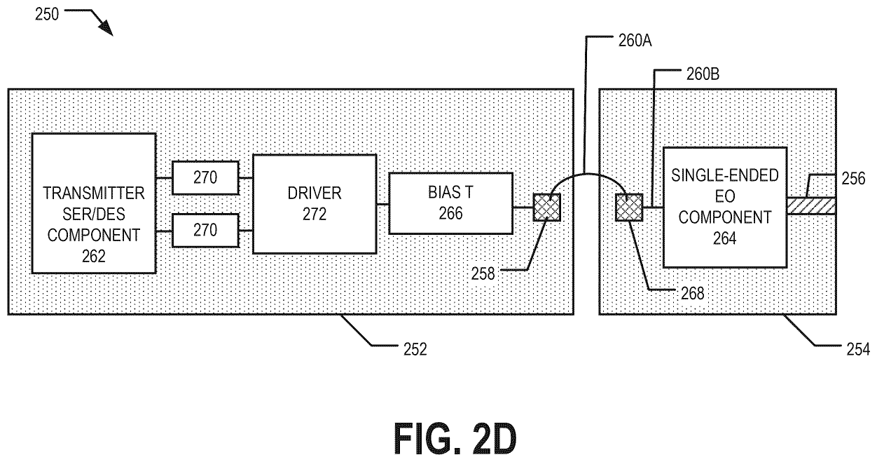

FIG. 2A provides a schematic top view of a transmitter assembly 200 and FIG. 2B provides a schematic sideview of the transmitter assembly 200, in accordance with various embodiments. For example, the transmitter assembly 200 includes a transmitter signal preparation component 212 on a board 202 (e.g., chip, printed-circuit board (PCB), interposer, and/or the like). A first bias T 216A and a second bias T 216B are also disposed on the board 202. The first bias T 216A is in electrical communication with a first output of the transmitter Signal preparation component 212 via a first trace 203A of the board 202, for example. The second bias T 216B is in electrical communication with a second output of the transmitter Signal preparation component 212 via a second trace 203B of the board 202, for example. In general, a bias T is an electrical component, such as a passive circuit, that allows for the injection of a DC bias voltage into an optical signal path while simultaneously permitting the transmission of high-frequency optical signals without disruption.

The first bias T 216A is in electrical communication with a first bonding pad 208A of the board 202 via a third trace of the board 202, for example. The second bias T 216B is in electrical communication with a second bonding pad 208B of the board 202 via a fourth trace of the board 202, for example.

A differential EO component 214 (e.g., an EML, a DFB-MZM chip, a DMZ coupled to an optical source/laser, an RMM coupled to an optical source/laser, and/or the like) is disposed and/or mounted on an optical sub-assembly 204. The differential EO component 214 is in electrical communication with a first bond pad 218A of the optical sub-assembly 204 (e.g., via wire 210C) and in electrical communication with a second bond pad 218B of the optical sub-assembly 204 (e.g., via wire 210D). The first bond pad 208A of the board 202 is in electrical communication with the first bond pad 218A of the optical sub-assembly via a first wire 210A soldered and/or bonded, for example, to the first bond pad 208A and the first bond pad 218A. The second bond pad 208B of the board 202 is in electrical communication with the second bond pad 218B of the optical sub-assembly via a second wire 210B soldered and/or bonded, for example, to the second bond pad 208B and the second bond pad 218B. Thus, the transmitter signal preparation component 212 is configured to provide a pair of electrical inputs 132 to the differential EO component 214. Notably, the pair of electrical paths (e.g., including traces of the board, the bias Ts 216A, 216B, bond pads 208A, 208B of the board 202, wires 210A, 210B, bond pads 218A, 218B of the optical sub-assembly 204, and traces of the optical sub-assembly) do not include separate or dedicated driver component configured for driving the differential EO component 214.

In some embodiments, the optical sub-assembly 204 further includes a waveguide 206 or other optical component(s) configured to couple the modulated optical signal generated by the differential EO component into an optical fiber 230. The optical fiber 230 then guides and/or provides the modulated optical signal to the receiver assembly of the optical interconnect that includes the transmitter assembly 200.

FIGS. 2C and 2D illustrate a conventional transmitter assembly 250. The conventional transmitter assembly 250 includes a transmitter SerDes component 262 that is in electrical communication with signal conditioning circuitry 270. The signal conditioning circuitry 270 comprises circuitry components (e.g., resistors, capacitors, and/or the like) that condition the electrical signal(s) provided by the transmitter SerDes component 262 in preparation for the electrical signal(s) to be provided to a driver 272. The driver 272 receivers the electrical signal(s) conditioned by the signal conditioning circuitry 270 and generates a driving signal. The driving signal is provided to a bias T 266 and then provided to an optical sub-assembly 254. The transmitter SerDes component 262, signal conditioning circuitry 270, driver 272, and bias T 266 are hosted by a board 252. In various embodiments, the respective (electrical) signals are provided and/or transmitted between components hosted on the board 252 by traces 253 of the board 252.

A bond pad 258 on the board 252, soldered wire 260A, and a bond pad 268 provide the driving signal to the optical sub-assembly 254. For example, wire 260B places the single-ended EO component 264 in electrical communication with the bond pad 268 disposed on the optical sub-assembly 254. The single-ended EO component 264 generates an optical signal that is provided to waveguide 256 for coupling into an optical fiber.

Notably, the conventional transmitter assembly 250 requires the signal conditioning circuitry 270 and the driver 272 to drive the single-ended EO component 264. The signal conditioning circuitry 270 and the driver 272 cause the transmitter assembly 250 to require additional electrical power compared to the transmitter assembly 200. Additionally, the heating of the optical sub-assembly 254 by the operation of the signal conditioning circuitry 270 and the driver 272 can have negative effects on the operation of the single-ended EO component 264.

### Example Optical Network

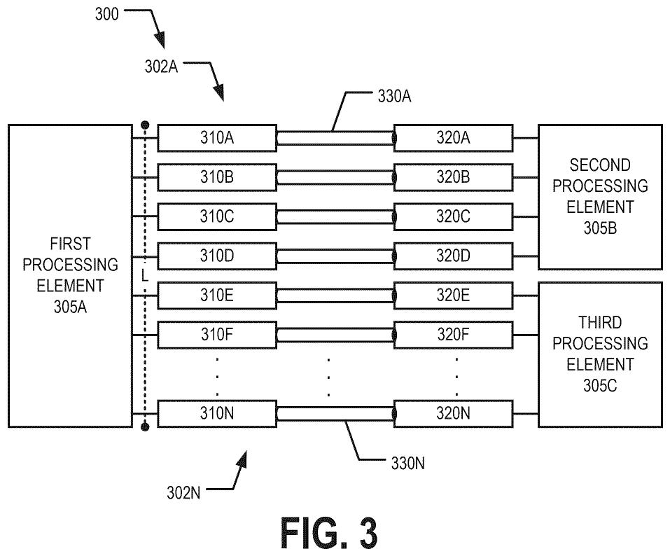

Various embodiments provide an optical network including a plurality of optical interconnects. For example, FIG. 3 illustrates at least a portion of an example optical network 300 comprising a plurality of optical interconnects 302 (e.g., 302A, . . . , 302N). For example, a first processing element 305A (e.g., a CPU, GPU, DPU, chip, and/or the like) is placed into communication with a second processing element 305B (e.g., another CPU, GPU, DPU, chip, and/or the like), by a first group of optical interconnects 302 such that one or more data streams generated by the first processing element 305A are communicated to the second processing element 305B via the first group of optical interconnects 302. A second group of optical interconnects 302 is configured to place the first processing element 305A into communication with a third processing element 305C (e.g., a different CPU, GPU, DPU, chip, and/or the like). In some embodiments, the optical network may also include groups of optical interconnects configured to communicate one or more data streams generated by the second processing element 305B to the first processing element 305A or one or more data streams generated by the third processing element 305C to the first processing element 305A. In an example embodiment, additional groups of optical interconnects 302 may be provided to provided communication between the second processing element 305B and the third processing element 305C.

In various embodiments, the optical network 300 may include a plurality of processing elements 305. For example, the illustrated at least a portion of the optical network 300 includes the first processing element 305A, the second processing element 305B, and a third processing element 305C. The optical network further comprises optical interconnects 302 that are arranged and/or configured to place respective pairs of processing elements into communication with one another.

Each optical interconnect 302 comprises a transmitter assembly 310 (e.g., 310A, . . . , 310N) that is electrical communication with a respective processing element 305. Each of the transmitter assemblies 310 may be similar to transmitter assemblies 110, 200. For example, a transmitter assembly 310 includes a transmitter signal preparation component and a differential EO component configured to be driven directly by the transmitter signal preparation component. The transmitter assembly 310 may further traces, leads, wires, bias Ts, bonding pads, waveguide and/or optical fiber coupling component, and/or the like configured for placing the components of the transmitter assembly into electrical and/or optical communication with one another and/or other components of the optical network 300.

Each optical interconnect 302 further comprises a receiver assembly 320 (e.g., 320A, . . . , 320N). In various embodiments, each of the receiver assemblies 320 are similar to receiver assembly 120. For example, a receiver assembly 320 may include an optical detector and a receiver signal processing component.

Each optical interconnect 302 further comprises an optical fiber 330 (e.g., 330A, . . . , 330N) that is in optical communication with the transmitter assembly 310 and the receiver assembly 320 of the optical interconnect 302.

A transmitter assembly 310 of an optical interconnect 302 is in communication with a respective processing element 305 and the receiver assembly 320 of the optical interconnect 302 is in communication with a different respective processing element 305 such that data streams may be communicated from the respective processing element 305 in communication with the transmitter assembly 310 to the other respective processing element 305 in communication with the receiver assembly 320. For example, the transmitter assembly 310N of the Nth optical interconnect 302N is in communication with the first processing element 305A and the receiver assembly 320N of the Nth optical interconnect 302N is in communication with the third processing element 305C such that one or more data streams may be communicated from the first processing element 305A to the third processing element 305C via the Nth optical interconnect 302N.

In various embodiments, the optical interconnects are configured to be placed into communication with respective processing elements in dense arrays. For example, the transmitter assemblies 310A-310N are arranged in a one-dimensional array of length L. In various embodiments, the number of transmitter assemblies N in the array and the length L are configured such that the density of transmitter assemblies is two or more transmitter assemblies per square millimeter. In various embodiments, processing elements 305 of the optical network are configured such that the density of optical interconnects is at least two optical interconnects per square millimeter at the processing element. In certain embodiments, the plurality of optical interconnects are arranged into one or more groups with at least one group having a density of at least two optical interconnects per square millimeter and/or 400 Gbps per square millimeter. For example, each optical interconnect may have a data rate of 200 Gbps. In other words, the density of the optical interconnects is limited by the footprint of the transceivers rather than cross-talk considerations.

Thus, various embodiments provide optical networks having a higher density (compared to conventional optical networks) of optical interconnects while maintaining the SNR and/or BER of the optical interconnects. For example, the optical interconnects, while more densely spaced, are less susceptible to crosstalk negatively affecting the SNR and/or BER of the optical interconnects. This provides an improvement in the ability to provide communication between processing elements in a spatially-conscious manner while requiring less electrical power.

### Example Method for Designing an Optical Interconnect

In various embodiments, the differential EO component of the transmitter assembly is configured to be driven directly by the transmitter Signal preparation component of the transmitter assembly. In various embodiments, a differential EO component is configured to be driven directly by the transmitter signal preparation component when the differential EO component is characterized by at least one, a plurality, or all of the parameters listed in Table 1.

By setting the specifications of the differential EO components to comply with the signal preparation component properties, the optical link performance can be optimized, and the link will benefit in terms of noise and linearity. Consequently, less signal processing is needed along the link (at Tx and/or Rx sides), reducing computation and energy consumption. In various embodiments, these parameters are determined based on a design process that uses a model of the optical interconnect as a whole. For example, when each component of the optical interconnect is optimized or designed individually, the optical interconnect formed by connecting the individually optimized or design components may not be functional. In various embodiments, a method for designing an optical interconnect comprises modeling interactions between components of a transmitter assembly and between components of a receiver assembly of the optical interconnect such that the optical interconnect is modeled as a whole.

Based on the model of the optical interconnect as a whole, one or more parameters of the optical interconnect and/or components thereof may be determined and/or optimized under at least one noise criteria to determine parameters that enable a functional optical interconnect.

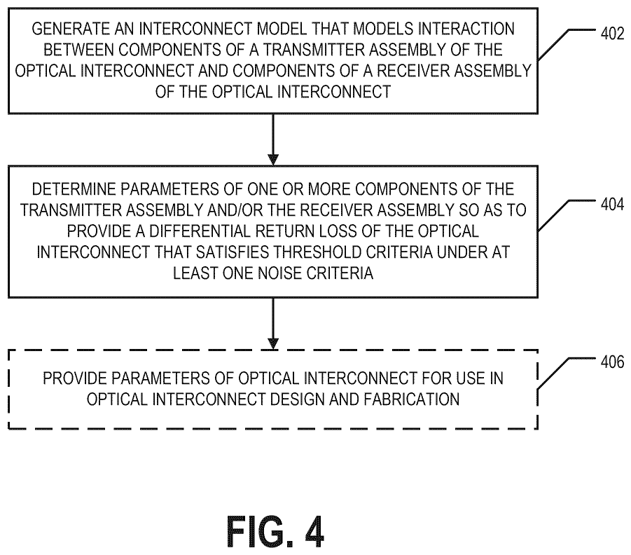

FIG. 4 provides a flowchart illustrating various processes and/or procedures for designing an optical interconnect comprising a differential EO component configured to be directly driven by the transmitter signal preparation component, for example. Starting at step 402, an interconnect model is generated. The interconnect model models and/or simulates interactions between components of the transmitter assembly of the optical interconnect and components of a receiver assembly of the optical interconnect. For example, the interconnect model models and/or simulates the end-to-end performance of the optical interconnect (e.g., transmitter signal preparation component to receiver signal processing component). For example, the interconnect model includes information regarding the performance of the transmitter signal preparation component, the pair of electrical signals generated by the transmitter signal preparation component and provided as input to the differential EO component, the operation of the differential EO component based on at least the pair of electrical signals provided as input to the differential EO component, the interaction between the modulated optical signal and the optical fiber, the interaction between the modulated optical signal and the optical detector, and the performance of the receiver signal processing component in response to the electrical signal generated by the optical detector being provided thereto.

In various embodiments, the interconnect model comprises sub-models of each component, each optical connection, and each electrical connection relevant for the performance of the optical interconnect (signal preparation component, high-speed (electrical) signal traces, differential EO components, optical fiber, etc.). Each sub-model of a component, an optical connection, or an electrical connection is based on measurement data; mathematical, physical, and circuit-theoretical principles; or a combination of measurement data and these principles. As an illustrative example, mathematical, physical, and circuit-theoretical principles, such as Ohm's law, may be used to determine an amount of current through an (electrical) signal trace. Various other physical laws may be used to model the performance and interaction of various components, optical connections, and/or electrical connections of the optical interconnect.

In some embodiments, the model is configured to enable the performance of the optical interconnect to be modeled and/or simulated under one or more noise criteria (e.g., type/color of noise, amplitude of noise, which component the noise is applied to, and/or the like).

In various embodiments, generating the model comprises interacting with a computer and writing computer program code that encodes the model and routines for determining one or more observables based on the model (e.g., BER, differential return loss SDD11, and/or the like). In various embodiments, generating the model comprises providing one or more parameters, interaction descriptions (e.g., possibly in the form of equations) via an interactive user interface (IUI), for example, of a computer. The one or more parameters, interaction descriptions, and/or the like may then be inserted into pre-prepared computer program code. In various embodiments, the model of the optical interconnect may be generated using a variety of techniques.

At step 404, the model of the optical interconnect is used to determine one or more parameters of one or more components of optical interconnect (e.g., one or more components of the transmitter assembly and/or the receiver assembly) such that the differential return loss (e.g., SDD11) of the optical interconnect satisfies one or more threshold criteria under at least one noise criteria. For example, the model may be configured such that the (end-to-end) performance of the optical interconnect may be modeled and/or simulated under one or more noise criteria. The value of a selected parameter may be swept through a corresponding value range while the remaining adjustable parameters of the model constant to determine the effect of the selected parameter on the (end-to-end) performance of the optical interconnect under one or more noise criteria.

For example, in certain embodiments, one or more or each design parameter of the differential EO component are swept over respective ranges, including the noise generation of the differential EO component and the differential return loss of the EO component. Each selected set of design parameters (selected by selecting particular values for the design parameters within the respective ranges) corresponds to a simulation point. E.g., for each simulation point, the performance of the complete optical interconnect is verified. For example, one or validation parameters may be determined and compared to a respective threshold. One example validation parameter is the bit error rate (BER). For example, in certain embodiments, when the BER determined for a simulation point satisfies a BER threshold (e.g., the determined BER is less than the BER threshold), the complete optical interconnect is considered to be functional at the simulation point and the corresponding set of design parameters are determined to be a functional set of design parameters. By comparing, compiling, and/or aggregating, the functional sets of design parameters determined through this process, the parameters of the differential EO component may be determined. For example, ranges of parameters of the differential EO component that, according to the simulations, will yield a functional optical interconnect are determined based on the functional sets of design parameters.

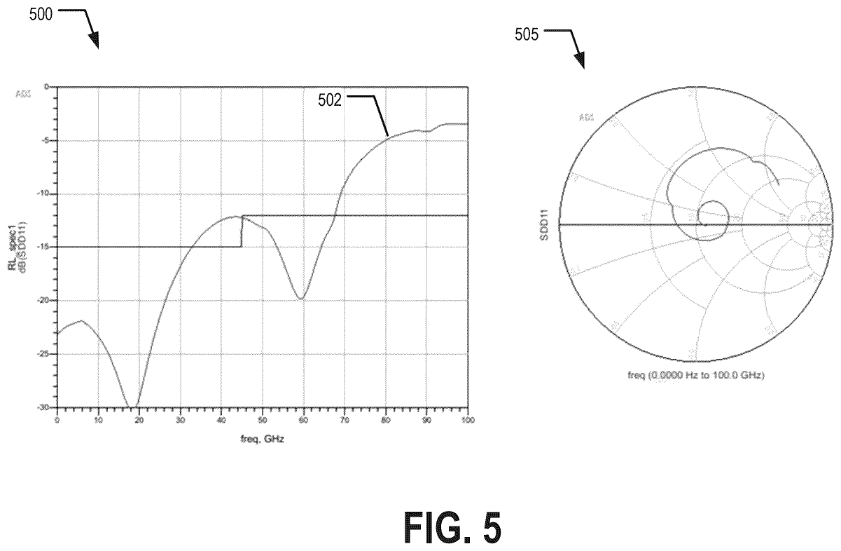

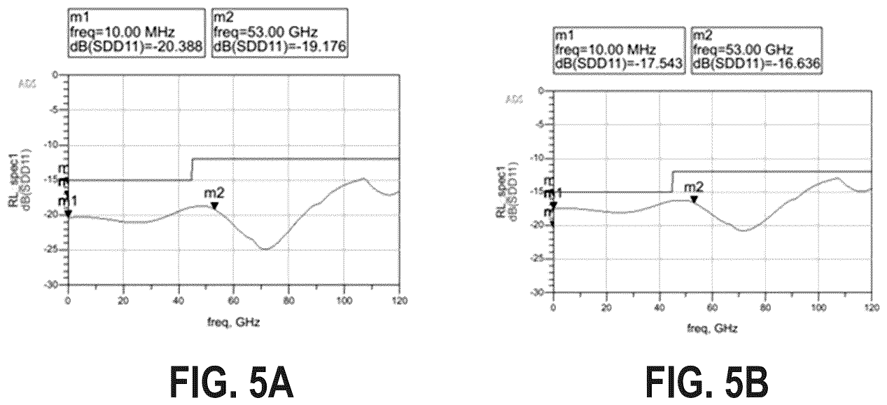

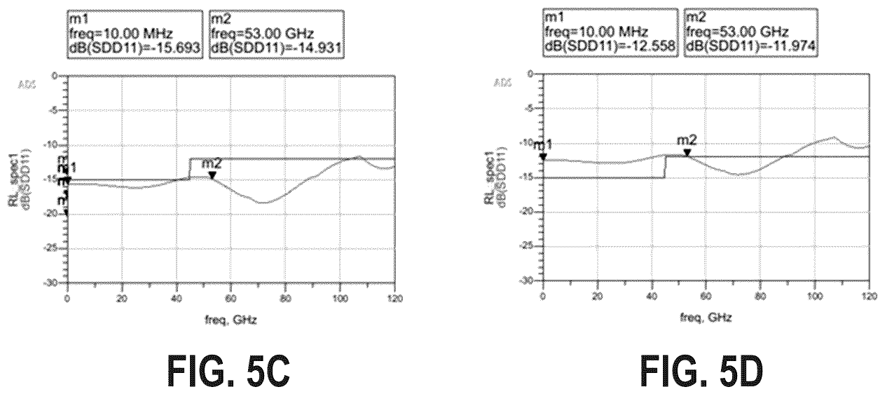

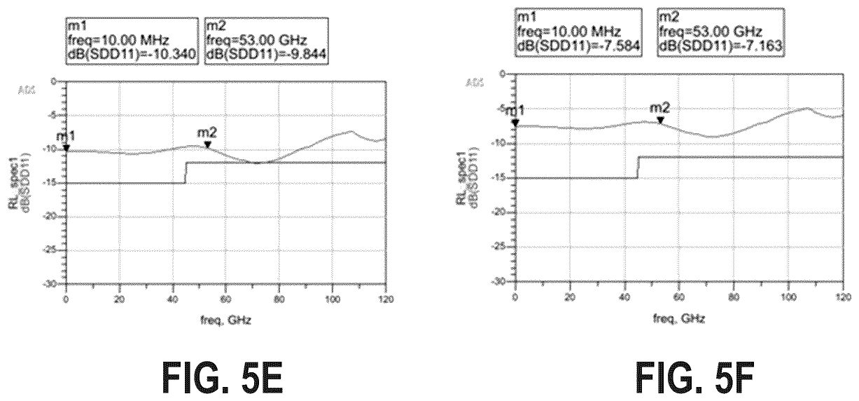

For example, plot 500 shown in FIG. 5 illustrates the magnitude 502 of the differential return loss SDD11 as a function of frequency for an example model of an differential EO component. The (blue) step function shown in the plot illustrates the SDD11 parameter values summarized in Table 1. For example, the one or more parameters may be determined such that, based at least in part on at least one noise criteria, the magnitude 502 of the differential return loss SDD11 is less than the threshold at one or more frequencies of interest. FIG. 5 also provides a Smitch chart 505 having the differential return loss SDD11 plotted thereon.

FIGS. 5A-5F each provide a plot that illustrates the differential return loss SDD11 of the optical interconnect as a function of frequency as the return loss of the differential EO component is swept through a range of values (e.g., −20 dB at 10 MHz in FIG. 5A up to −7.5 dB at 10 MHz in FIG. 5F). For example, the signal preparation component provides a pair of electrical inputs that each include a plurality of components each characterized by a respective frequency. For example, each of the electrical inputs of the pair of electrical inputs may be decomposed into a sum of sine waves with specific frequencies, amplitudes, and phases (using e.g., Fourier transformation). The differential return loss (SDD11) illustrates how much signal power is reflected compared to the incident signal power for each sine wave of a given frequency. As a result, FIGS. 5A-5F provide insight into the optical interconnect's (as a system) impedance matching and reflection behavior across the frequency spectrum.

In FIGS. 5A-5C, the magnitude of the differential return loss SDD11 satisfies the threshold criteria (e.g., is below the (blue) step function illustrating the threshold criteria) for all frequencies up to 60 GHz, as reflected by Table 1. However, in FIGS. 5D-5F, the magnitude of the differential return loss SDD11 does not satisfy the threshold criteria (e.g., is at or above the (blue) step function illustrating the threshold criteria) for at least one frequency up to 60 GHz. Thus, it may be determined that the optical interconnect is a functional optical interconnect when the return loss of the differential EO component is less than the value of the return loss of the differential EO component used to generate FIG. 5D and/or no more than the value of the return loss of the differential EO component used to generate FIG. 5C. The acceptable ranges of various design parameters of the differential EO component may be determined using a similar process.

A variety of parameters of the optical interconnect (e.g., parameters of the differential EO component) may be determined by sweeping the respective parameters through respective ranges of values to determine the respective parameters' effects on the performance of the optical interconnect and identifying parameter values based thereon such that the performance of the optical interconnect (e.g., as represented by the differential return loss SDD11, BER, and/or the like) satisfies one or more threshold criteria under at least one noise criteria.

In various embodiments, the effects of the respective parameters on the performance of the optical interconnect may be determined by executing the program code using a computer. In some embodiments, the parameter values are identified automatically (e.g., via execution of the program code via the computer). In some embodiments, the computer may execute the program code and provide plots similar to those shown in FIGS. 5-5F, tables, and/or the like such that a human technician may identify the parameter values based thereon.

In some embodiments, at step 406, the identified parameter values of the optical interconnect are provided. For example, the identified parameter values may be provided via a data file stored in a (non-transitory) memory, via a display of the computer, and/or the like. The identified parameter values may then be used in designing and/or fabricating the optical interconnect. For example, the identified parameter values may indicate parameter values required by the differential EO component of a transmitter assembly such that the differential EO component is configured to be driven directly by the transmitter signal preparation component.

### Example Datacenter

In various embodiments, a system including an optical interconnect 100 and/or an optical network 300 may be part of a datacenter. For example, the system may be used to place various components of a datacenter in communication with one another. In various embodiments, the system may include a pluggable optical interconnect that uses a differential EO component configured to be directly driven by the transmitter signal preparation component, a chip-to-chip optical interconnect that uses a differential EO component configured to be directly driven by the transmitter signal preparation component, an optical network comprising a plurality of optical interconnects that each use a respective differential EO component configured to be directly driven by the transmitter signal preparation component and/or the like. For example, the system may be used to (optically) transmit data between components of a datacenter, in various embodiments. For example, a transmitter assembly 110, 200 may be used to generate optical signals that are transmitted along one or more optical communication paths between two components of a datacenter, in accordance with an example embodiment.

Datacenters may include multiple network switches in a particular topology, such as a fat tree topology, a slim fly topology, a dragonfly topology, and/or the like. The specifications and makeup of the network switches in the topology affects the overall network performance (e.g., bandwidth capability) of the datacenter.

Datacenters are the storage and data processing hubs of the internet. The massive deployment of cloud applications is causing datacenters to expand exponentially in size, stimulating the development of faster switches than can cope with the increasing data traffic inside the datacenter. Current state-of-the-art switches are capable of handling 12.8 Tb/s of traffic by employing electrical switches in the form of application specific integrated circuits (ASICs) equipped with 256 data lanes, each operating at 50 Gbps. Such switching ASICs typically consume as much as 400 W, and the power consumption of the optical transceiver interfaces attached to each ASIC is comparable. To keep pace with traffic demand, switch capacity doubles approximately every two years. To date, this rapid scaling has been made possible by exploiting advances in manufacturing (e.g., CMOS techniques), collectively described by Moore's law (i.e., the observation that the number of transistors in a dense integrated circuit doubles about every two years). However, in recent years there are strong indications of Moore's law slowing down, which raises concerns about the capability to sustain the target scaling rate of switch capacity. As a result, alternative technologies are being investigated.

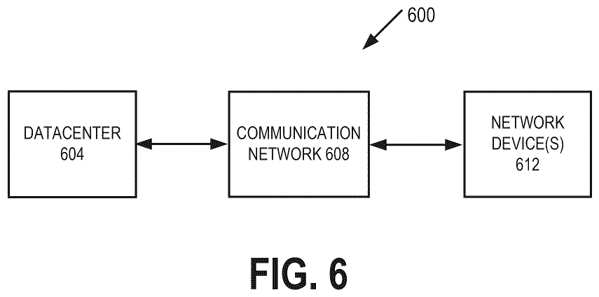

FIG. 6 illustrates a system 600 according to at least one example embodiment. The system 600 includes a datacenter 604, a communication network 608, and one or more network devices 612. In at least one example embodiment, the datacenter 604 corresponds to a collection of network devices, such as network switches (e.g., Ethernet switches) connected with a collection of servers or compute nodes. The datacenter 604 may adhere to a networking topology (e.g., a hierarchal networking topology), such as a fat tree topology, a Slim Fly topology, a Dragonfly topology, and/or the like. The datacenter 604 routes traffic amongst the network switches and servers therein, and at least one layer of the topology in the datacenter 604 is coupled to the communication network 608 to allow networking traffic to flow between the datacenter 604 and the network device(s) 612.

Examples of the communication network 608 that may be used to connect the datacenter 604 and the network device(s) 612 include an Internet Protocol (IP) network, an Ethernet network, an InfiniBand (TB) network, a Fibre Channel network, the Internet, a cellular communication network, a wireless communication network, combinations thereof (e.g., Fibre Channel over Ethernet), variants thereof, and/or the like.

The one or more network devices 612 may include switch, router, or Network Interface Controller (NIC), interconnect using ports, one or more of Personal Computer (PC), a laptop, a tablet, a smartphone, a server, a collection of servers, and/or any suitable computing device for sending and receiving signals over the communication network 608. In at least one example embodiment, the one or more network devices 612 correspond to another datacenter, similar to or the same as datacenter 604.

As noted above, the datacenter 604 and/or the network device(s) 612 may include storage devices and/or processing circuitry for carrying out computing tasks, for example, tasks associated with controlling the flow of data internally and/or over the communication network 608. Such processing circuitry may comprise software, hardware, or a combination thereof. For example, the processing circuitry may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory).

Additionally or alternatively, the processing circuitry may comprise hardware, such as an application specific integrated circuit (ASIC). For example, the processor may be or include one or more of an Integrated Circuit (IC) chip, a microprocessor, a Central Processing Unit (CPU), a Graphics Processing Unit (GPU), a Data Processing Unit (DPU), a Field Programmable Gate Array (FPGA), a network interface controller (NIC), an ASIC, combinations thereof, and the like. The processing circuitry may comprise an ASIC and/or may be capable of performing as a central processing unit (CPU), a graphics processing unit (GPU), a network interface controller (NIC), a data processing unit (DPU), or any other computing device in which with data is received and/or transmitted.

Some or all of the processing circuitry may be provided on a Printed Circuit Board (PCB) or collection of PCBs. It should be appreciated that any appropriate type of electrical component or collection of electrical components may be suitable for inclusion in the processing circuitry.

In addition, although not explicitly shown, it should be appreciated that the datacenter 604 and network device(s) 612 may include one or more communication interfaces for facilitating wired and/or wireless communication between one another and other unillustrated elements of the system 600.

In related art systems, a fat tree topology may use the same electrical switching devices on all layers (edge, aggregation, core). For example, each switching device may be 1 U switch, where 1 U refers to the industry standard size for rack-mounted switch and/or server. The interconnection between switches of different layers may be accomplished with optical links or optical interconnects using active optical cables and optical transceivers implemented in a pluggable form factor (also referred to as “pluggables”).

Optical Datacenter Networks rely on allocation and deallocation of light paths from the data sources to the destinations end-ports to guarantee no light collisions and data loss occur in the fabric. Traditionally the allocation algorithms are run from a central entity which considers the entire demand for source and destination flows and try to find the most dense mapping of these demands to network resources over a single or multiple time periods.

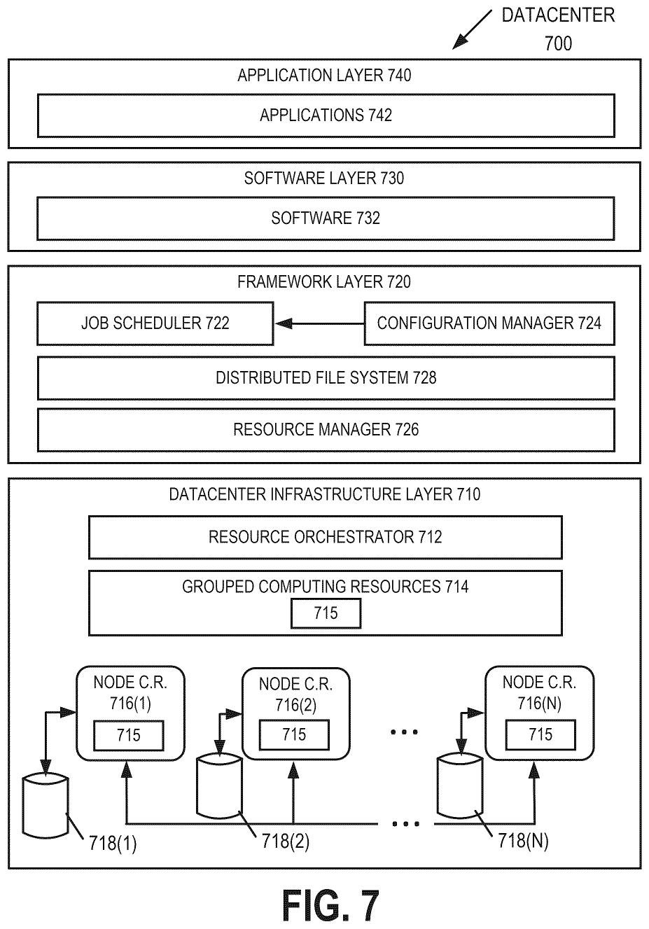

FIG. 7 illustrates an example datacenter 700, in which at least one embodiment may be used. In at least one embodiment, datacenter 700 includes a datacenter infrastructure layer 710, a framework layer 720, a software layer 730, and an application layer 740.

In at least one embodiment, as shown in FIG. 7, datacenter infrastructure layer 710 may include a resource orchestrator 712, grouped computing resources 714, and node computing resources (“node C.R.s”) 716(1)-716(N), where “N” represents a positive integer (which may be a different integer “N” than used in other figures). In at least one embodiment, node C.R.s 716(1)-716(N) may include, but are not limited to, any number of central processing units (“CPUs”) or other processors (including accelerators, field programmable gate arrays (FPGAs), graphics processors, etc.), memory storage devices 718(1)-718(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in datacenters at various geographical locations (also not shown). In at least one embodiment, separate groupings of node C.R.s within grouped computing resources 714 may include grouped compute, network, memory, or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 712 may configure or otherwise control one or more node C.R.s 716(1)-716(N) and/or grouped computing resources 714. In at least one embodiment, resource orchestrator 712 may include a software design infrastructure (“SDI”) management entity for datacenter 700. In at least one embodiment, resource orchestrator 712 may include hardware, software or some combination thereof.

In at least one embodiment, as shown in FIG. 7, framework layer 720 includes a job scheduler 722, a configuration manager 724, a resource manager 726 and a distributed file system 728. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may utilize distributed file system 728 for large-scale data processing (e.g., “big data”). In at least one embodiment, job scheduler 722 may include a Spark driver to facilitate scheduling of workloads supported by various layers of datacenter 700. In at least one embodiment, configuration manager 724 may be capable of configuring different layers such as software layer 730 and framework layer 720 including Spark and distributed file system 728 for supporting large-scale data processing. In at least one embodiment, resource manager 726 may be capable of managing clustered or grouped computing resources mapped to or allocated for support of distributed file system 728 and job scheduler 722. In at least one embodiment, clustered or grouped computing resources may include grouped computing resources 714 at datacenter infrastructure layer 710. In at least one embodiment, resource manager 726 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 728 of framework layer 720. In at least one embodiment, one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 728 of framework layer 720. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 724, resource manager 726, and resource orchestrator 712 may implement any number and type of self-modifying actions based on any amount and type of data acquired in any technically feasible fashion. In at least one embodiment, self-modifying actions may relieve a datacenter operator of datacenter 700 from making possibly bad configuration decisions and possibly avoiding underutilized and/or poor performing portions of a datacenter.

In at least one embodiment, datacenter 700 may include tools, services, software, or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to datacenter 700. In at least one embodiment, trained machine learning models corresponding to one or more neural networks may be used to infer or predict information using resources described above with respect to datacenter 700 by using weight parameters calculated through one or more training techniques described herein.

In at least one embodiment, datacenter may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. In at least one embodiment, inference and/or training logic 715 may be used in system FIG. 7 for inferencing or predicting operations based, at least in part, on weight parameters calculated using neural network training operations, neural network functions and/or architectures, or neural network use cases described herein.

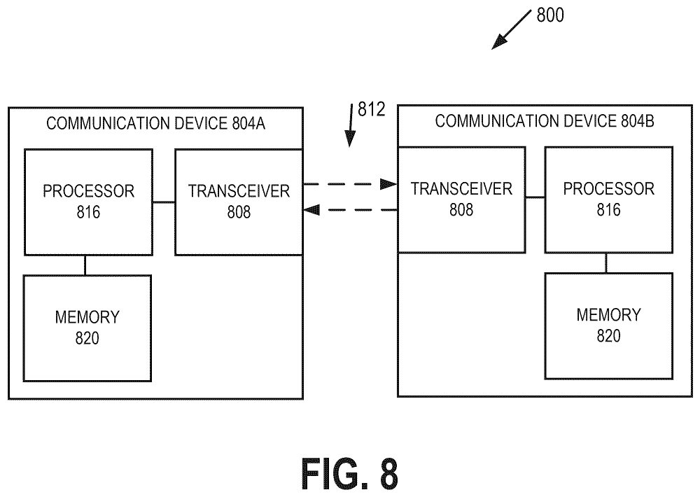

FIG. 8 illustrates a system 800 including a first communication device 804A and a second communication device 804B. Illustratively, but without limitation, the communication devices 804 (e.g., 804A, 804B) may correspond to network devices (e.g., network devices 612). As such, the communication devices 804 may correspond to any type of device that becomes part of or is connected with a communication network (e.g., communication network 608). Examples of suitable devices that may act or operate like a communication device 804 as described herein include, without limitation, one or more of a Personal Computer (PC), a laptop, a tablet, a smartphone, a server, a collection of servers, a networking card, an edge router, a switch, Network Interface Controller, a Top of Rack (ToR) switch, a server blade, or the like. The communication device 804 may include a transceiver 808, a processor 816, and memory 820. The transceiver 808 may include hardware that enables communications over the communication channel 812 whereas the processor 816 and memory 820 may include components that enable the communication device 804 to provide a desired functionality or perform certain functions.

The communication channel 812 may traverse a datacenter or any type of communication network (whether trusted or untrusted). Examples of a communication network that may be used to connect communication devices 804 and support the communication channel 812 include, without limitation, an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. In one specific, but non-limiting example, the communication network enables data transmission between the communication devices 804 using optical signals. In this case, the communication devices 804 and the communication network may include waveguides (e.g., optical fibers) that carry the optical signals. For example, the communication devices and/or the communication network may include one or more systems 400, according to various embodiments.

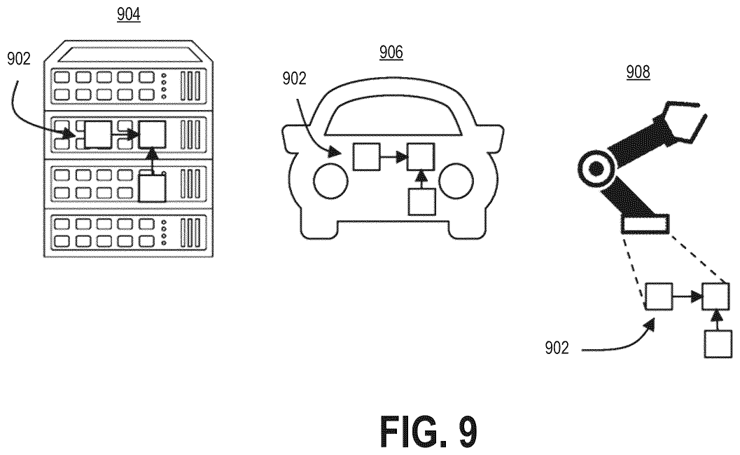

FIG. 9 depicts some exemplary scenarios for use of an optical transceiver 902 in accordance with some embodiments. An optical transceiver 902 may be utilized in a computing system 904 (e.g., in a server farm, or within a server computer system), a vehicle 906 (e.g., a car, truck, train, or airplane), and a robot 908 (or among robots in a factory), to name just a few examples. The optical transceiver 302 may be particularly useful for high-speed communication in environments subject to high levels of electromagnetic interference (EMI).

### Example System Use Case

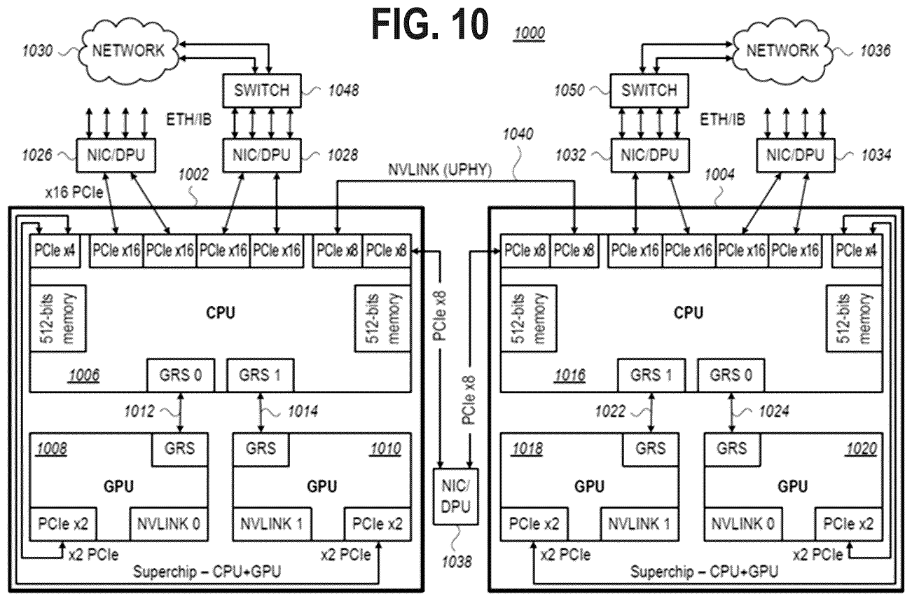

FIG. 10 is a block diagram that schematically illustrates a computing system 1000, e.g., a data center or a High-Performance Computing (HPC) cluster, in accordance with an embodiment that is described herein. System 1000 comprises a plurality of subsystems, e.g. multiple processing devices coupled to each other, multiple network devices, and multiple networks, according to at least one embodiment. Computing system 1000 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1000 and to one or more external networks 1030, 1036. In the present example, system 1000 comprises a packet switch 1048 that connects NIC/DPU 1028 to network 1030, and a packet switch 1050 that connects NIC/DPU 1032 to network 1036.

The coupling of processing devices through NVLink allows for seamless data exchange and parallel processing, enhancing overall computational performance. The processing devices are connected to multiple networks through one or more network interface controllers (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs.

FIG. 10 also demonstrates an example architecture of a multi-GPU architecture. As illustrated in the figure, computing system 1000 includes a processing device 1002 with a multi-GPU architecture. In particular, processing device 1002 may be a system-on-chip and includes multiple subsystems such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 3, CPU 1006 is coupled to a first NIC/DPU 1026, which is coupled to a network 1030. CPU 1006 is also coupled to a second NIC/DPU 1028, which is coupled to network 1030 via switch 1048. NIC/DPU 1026 and NIC/DPU 1028 can be coupled to network 1030 over Ethernet (ETH), NVLINK or InfiniBand (IB) connections, for example.

Computing system 1000 also includes a processing device 1004 with a multi-GPU architecture. In particular, processing device 1004 includes multiple subsystems including a CPU 1016, a GPU 1018, and a GPU 1020. CPU 1016 can be coupled to GPU 1018 via an D2D or C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 3, CPU 1016 is coupled to a first NIC/DPU 1032, which is coupled to a network 1036. CPU 1016 is also coupled to a second NIC/DPU 1034, which is coupled to network 1036 via switch 1050. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communication with each other via a NIC/DPU 1038, such as over PCIe interconnects. Processing device 1002 and processing device 1004 can also communicate with each other over a high-bandwidth communication interconnects 1040, such as an NVLink interconnect or other high-speed interconnects. The packet switches in FIG. 3 may comprise, for example, Nvidia Quantum-2 switches. The NICs/DPUs in the figure may comprise, for example, Nvidia Bluefield DPUs.

In various embodiments, one or more of the interconnects 1012, 1014, 1022, 1024 may be optical interconnects disclosed herein. Additionally, in various embodiments, switches 1048, 1050 may be in communication with NIC/DPU 1028, 1032, respectively, via one or more optical interconnects disclosed herein. In some embodiments, NIC/DPU 1026, 1034 may be in communication with one or more additional elements via optical interconnects disclosed herein. For example, various elements of the computing system 1000 may be in communication with one another via one or more optical interconnects disclosed herein.

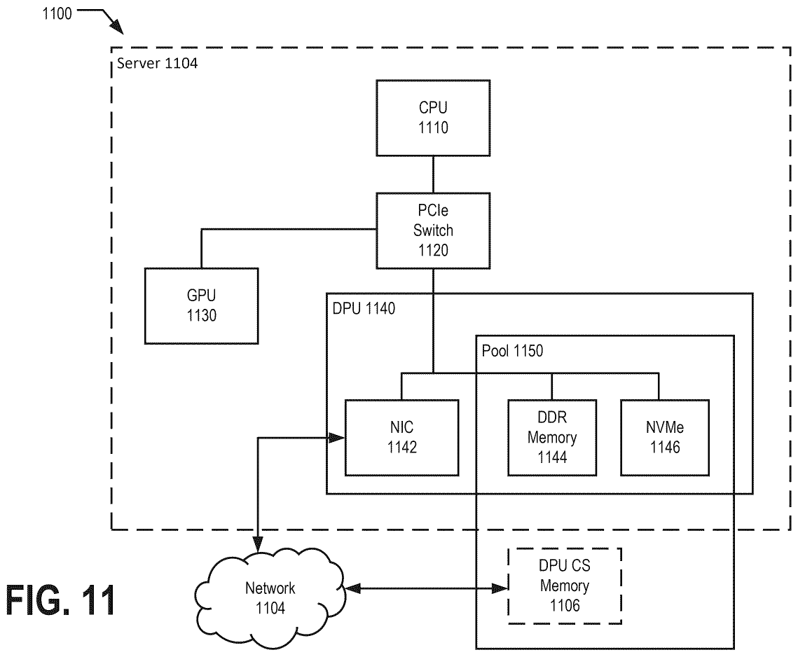

FIG. 11 illustrates an example computing environment 1100 in which forward pass offloading to available memory can be performed, in accordance with at least one embodiment. It should be appreciated that embodiments of the present disclosure may also be used with reference to alternative environments and that specific discussion of components may be provided by way of non-limiting example and may include equivalents. Moreover, various features have been removed for clarity and conciseness. Additionally, systems and methods may be used with a variety of different architectures. The example computing environment 1100 may include a server 1102 which may be used to perform high performance computing (HPC) workloads, such as AI training or machine learning model training. In an embodiment, the server 1102 may be an application instance or a compute node. The server 1102 may include a CPU 1110 associated with a switch 1120, such as a peripheral component interconnect express (PCIe) switch, which may control at least some data transmission over communication paths interconnecting various components. In an embodiment, the CPU 1110 may include a root complex processor.

The PCIe switch 1120 may also be associated with a GPU 1130 and a DPU 1140, and may transmit data between at least some of the CPU 1110, the GPU 1130, the DPU 1140, and other components (e.g., via one or more optical interconnects disclosed herein). In an embodiment, the PCIe switch 1120 may be associated with more than one GPU or more than one DPU. In another embodiment, the PCIe switch 1120 may be located within the DPU 1140. The PCIe switch 1120 may manage the transfer of at least some data between the CPU 1110, the GPU 1130, and the DPU 1140. In another embodiment, the number of GPUs associated with the PCIe switch 1120 may be equal to the number of DPUs associated with the PCIe switch 1120. In at least one embodiment, the server 1102 may include, without limitation, any number of the CPUs 1110, the PCIe switches 1120, the GPUs 1130, and/or the DPUs 1140, in any combination. For example, in at least one embodiment, server 1102 could include eight, sixteen, thirty-two, and/or more GPUs 1130. In at least one embodiment, communication paths interconnecting various components, including but not limited to the CPU 1110, the PCIe switch 1120, the GPU 1130, and the DPU 1140, in FIG. 11 may be implemented using any suitable protocols, such as peripheral component interconnect (PCI) based protocols (e.g., PCIe), or other bus or point-to-point communication interfaces and/or protocol(s), such as NV-Link high-speed interconnect, or interconnect protocols.

The DPU 1140 may include a network interface controller (NIC) 1142, a DDR memory 1144, and a non-volatile memory express (NVMe) device 1146. The NIC 1142 may be able to interface with a network 1104, which may also interface with additional NVMe devices available to the DPU 1140, such as over fabric. In an embodiment, the DPU 1140 may not include the NVMe device 1146. In another embodiment, the NVMe device 1146 may be located on the server 1102 and not on the DPU 1140. In yet another embodiment, the computing environment 1100 may include more than one of the NVMe device 1146, such as a first NVMe device in the DPU 1140 and a second first NVMe device on the server 1102 an associated directly with the PCIe switch 1120. In an embodiment, the DPU 1140 may not include the DDR memory 1144 and may include a computational storage services (CSS) in place of, or in addition to, the DDR memory 1144. For example, computing environment 1100 may include DPU computational storage (CS) memory 1106 available to the DPU 1140 as part of the CSS. The network 1104 may be able to interface with the DPU CS memory 1106 through the NIC 1142, according to any suitable interface protocol, such as remote direct memory access (RDMA) over Ethernet, InfiniBand, Fiber Channel, etc.

The total memory of the computing environment 1100 available for data storage may be expanded through the use of the DPU 1140 on nodes of the system. The DPU 1140 may have access to a pool 1150 of memory already available to the server 1102, such as double data rate (DDR) memory, on-board NVMe devices, NVMe devices over fabric, and CS. The pool 1150 of memory may include at least one of the DDR memory 1144, NVMe 1146, and the DPU CS memory 1106. The DPU 1140 may also be able to access the available memory of other DPUs as part of the pool 1150, and other DPUs may be able to access the available memory of DPU 1140, such as the pool 1150. This available memory can be accessed and utilized for data storage, without the addition of compute resources, such as compute nodes, which would be required using other solutions. The available pool 1150 accessible to the DPU 1140 may be provisioned for the server 1102 to expand the total memory available for data storage, such as to reduce the data storage load on the CPU 1110 or the GPU 1130, which can instead increase the utilization of their memory for processing. For example, during training of an AI, the model states, residual states, activation functions, and checkpoints can be stored, or offloaded, on the pool 1150 accessible to the DPU 1140.

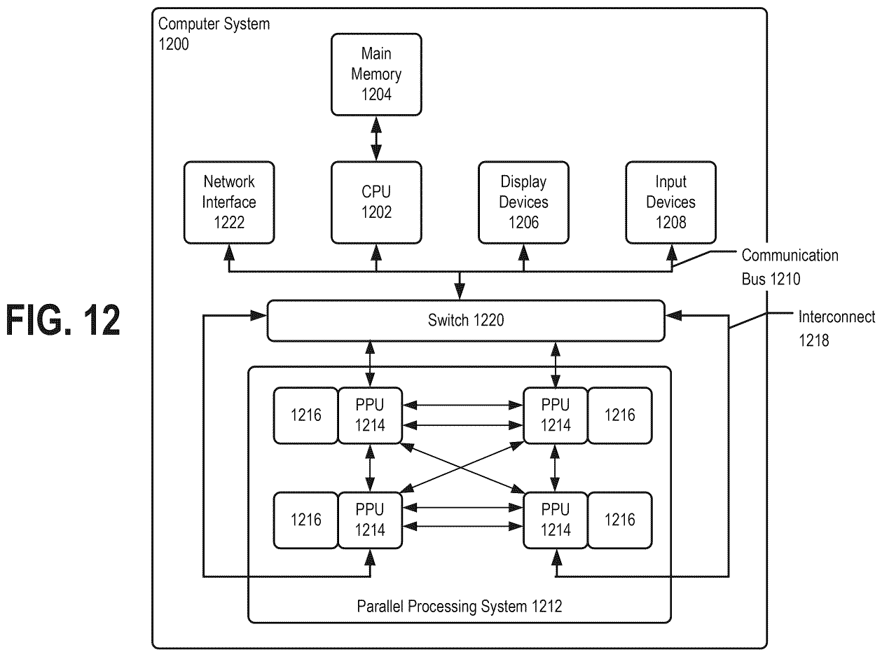

FIG. 12 illustrates a computer system 1200, according to at least one embodiment. In at least one embodiment, computer system 1200 comprises at least one optical interconnect of an example embodiment.

In at least one embodiment, computer system 1200 comprises, without limitation, at least one central processing unit (“CPU”) 1202 that is connected to a communication bus 1210 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 1200 includes, without limitation, a main memory 1204 and control logic (e.g., implemented as hardware, software, or a combination thereof) and data are stored in main memory 1204 which may take form of random access memory (“RAM”). In at least one embodiment, a network interface subsystem (“network interface”) 1222 provides an interface to other computing devices and networks for receiving data from and transmitting data to other systems from computer system 1200.

In at least one embodiment, computer system 1200, in at least one embodiment, includes, without limitation, input devices 1208, parallel processing system 1212, and display devices 1206 which can be implemented using a conventional cathode ray tube (“CRT”), liquid crystal display (“LCD”), light emitting diode (“LED”), plasma display, or other suitable display technologies. In at least one embodiment, user input is received from input devices 1208 such as keyboard, mouse, touchpad, microphone, and more. In at least one embodiment, each of foregoing modules can be situated on a single semiconductor platform to form a processing system.

In at least one embodiment, computer programs in form of machine-readable executable code or computer control logic algorithms are stored in main memory 1204 and/or secondary storage. Computer programs, if executed by one or more processors, enable system 1200 to perform various functions in accordance with at least one embodiment. memory 1204, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of CPU 1202; parallel processing system 1212; an integrated circuit capable of at least a portion of capabilities of both CPU 1202; parallel processing system 1212; a chipset (e.g., a group of integrated circuits designed to work and sold as a unit for performing related functions, etc.); and any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, computer system 1200 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 1212 includes, without limitation, a plurality of parallel processing units (“PPUs”) 1214 and associated memories 1216. In at least one embodiment, PPUs 1214 are connected to a host processor or other peripheral devices via an interconnect 1218 and a switch 1220 or multiplexer. In at least one embodiment, parallel processing system 1212 distributes computational tasks across PPUs 1214 which can be parallelizable—for example, as part of distribution of computational tasks across multiple graphics processing unit (“GPU”) thread blocks. In at least one embodiment, memory is shared and accessible (e.g., for read and/or write access) across some or all of PPUs 1214, although such shared memory may incur performance penalties relative to use of local memory and registers resident to a PPU 1214. In at least one embodiment, operation of PPUs 1214 is synchronized through use of a command such as_syncthreads ( ) wherein all threads in a block (e.g., executed across multiple PPUs 1214) to reach a certain point of execution of code before proceeding.

The PPUs 1214 may be in communication with one another and/or switch 1220 via one or more optical interconnects in accordance with example embodiments disclosed herein.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An optical interconnect comprising:
a transmitter assembly comprising:
a differential electro-optical component configured to generate a modulated optical signal; and
a signal preparation component, wherein the differential electro-optical component is configured to be directly driven by the signal preparation component.

2. The optical interconnect of claim 1, wherein the differential electro-optical component is configured to receive at least one pair of electrical inputs and provide an optical output based on a comparison of the at least one pair of electrical inputs.

3. The optical interconnect of claim 1, wherein the signal preparation component comprises circuitry configured to convert parallel data to serial data.

4. The optical interconnect of claim 1, wherein the differential electro-optical component is configured to have a 3 dB bandwidth of at least 60 GHz, a modulation voltage of no more than 0.9 peak-to-peak voltage (Vpp) differential into 86 Ohms, a relative intensity noise (RIN) referred to optical modulation amplitude (OMA) measured at 3.5 dBm of no more than −150 dBc/Hz, a radiofrequency (RF) facet optical power of at least 5 dBm, and a differential input reflection coefficient (SDD11) with reference 86 Ohms of no more than −15 dB up to 45 GHz and of no more than −12 dB up to 60 GHz.

5. The optical interconnect of claim 4, wherein for performing pulse amplitude modulation 4 (PAM4) transmission, the differential electro-optical component is configured to have an outer RF extinction ratio of at least 5 dB and a level separation mismatch ratio (RLM) of at least 0.95.

6. The optical interconnect of claim 1, wherein the transmitter assembly is configured to transmit the modulated optical signal, wherein the modulated optical signal encodes one or more data streams.

7. The optical interconnect of claim 6, wherein the signal preparation component is configured to drive the differential electro-optical component to cause the modulated optical signal to encode the one or more data streams.

8. The optical interconnect of claim 6, further comprising a receiver assembly, the receiver assembly comprising an optical detector configured to convert the modulated optical signal into at least one electrical signal encoding the one or more data streams.

9. The optical interconnect of claim 8, wherein the receiver assembly further comprises a receiver signal processing component configured to convert the at least one electrical signal encoding the one or more data streams into individual electrical signals each encoding one of the one or more data streams.

10. The optical interconnect of claim 1, wherein the differential electro-optical component comprises a laser and a differential electro-optical modulator configured to modulate an output of the laser.

11. The optical interconnect of claim 1, wherein the differential electro-optical component comprises an electro-absorption modulated laser (EML) or a distributed feedback (DFB)-Mach-Zehnder modulator (MZM) chip.

12. The optical interconnect of claim 1, wherein the differential electro-optical component comprises a dual Mach-Zehnder modulator (DMZ) or a ring resonator modulator (RRM).

13. The optical interconnect of claim 1, wherein the signal preparation component is configured to provide a pair of electrical inputs to the differential electro-optical component.

14. The optical interconnect of claim 13, wherein the signal preparation component is configured to provide the pair of electrical inputs to the differential electro-optical component without providing any input to a laser driver in electrical communication that is in communication with the differential electro-optical component.

15. The optical interconnect of claim 1, wherein the signal preparation component is at least one of a serializer/deserializer (SerDes) or a peripheral component interconnect express (PCIe) component.

16. An optical network comprising:
a plurality of optical interconnects, each optical interconnect comprising a respective differential electro-optical component driven directly by a respective signal preparation component.

17. The optical network of claim 16, wherein the plurality of optical interconnects are arranged into one or more groups with at least one group having a density of at least two optical interconnects within one square millimeter.

18. The optical network of claim 16, wherein the respective differential electro-optical component is configured to have a 3 dB bandwidth of at least 60 GHz, a modulation voltage of no more than 0.9 peak-to-peak voltage (Vpp) differential into 86 Ohms, a relative intensity noise (RIN) referred to optical modulation amplitude (OMA) measured at 3.5 dBm of no more than −150 dBc/Hz, a radiofrequency (RF) facet optical power of at least 5 dBm, and a differential input reflection coefficient (SDD11) with reference 86 Ohms of no more than −15 dB up to 45 GHz and of no more than −12 dB up to 60 GHz.

19. The optical network of claim 18, wherein for performing pulse amplitude modulation 4 (PAM4) transmission, the differential electro-optical component is configured to have an outer RF extinction ratio of at least 5 dB and a level separation mismatch ratio (RLM) of at least 0.95.

20. The optical network of claim 16, further comprising a plurality of processing elements, wherein the plurality of processing elements are in communication with one another via the plurality of optical interconnects.
